(19) United States
(12) Patent Application Publication
(10) Pub. No.: US 2008/0053878 A1
(43) Pub. Date: Mar. 6, 2008

(54) In-Feed Distributing Unit

(76) Inventor: Egill Thor Ragnarsson, Gardabaer (IS)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/597,206

(22) PCT Filed: May 24, 2005
(86) PCT No.: PCT/IS05/00013

§ 371 Date: Aug. 2, 2007

(30) Foreign Application Priority Data
May 24, 2004 (IS) 7285

(51) Int. Cl. A22C 25/12

(52) U.S. Cl. 209/660

(57) ABSTRACT

The present invention relates to an in-feed distributing unit for distributing an uneven stream of individual elongated objects prior to be grading.

### FIELD OF THE INVENTION

The present invention relates to an in-feed distributing unit for distributing an uneven stream of individual elongated objects prior to grading.

### BACKGROUND

The grading of objects such as fish and marine species such as capilion, herring, shrimp as well as other species can be a difficult task. The reason being their small size and the volume to be processed at each time combined with that the quality of fish deteriorates quickly if not stored at sub zero temperature. The grading therefore has to be highly efficient.

The purpose of the grading is primarily to separate each species by size and/or sex.

An effective apparatus exist using a plurality of endless ridge belts which are drawn by a drive along guiding units. The distance between the belts being wider at the output end than at the intake end so that the objects falls down into grading compartments as the distance between the belts gets greater than the objects.

An essential part for such grading machines is the in-feeding mechanism for ensuring that the objects, when they enter the in-feed end of the grading machine, are uniformly distributed. This has been solved in different ways. One preferred way is to use a plurality of incline stages/steps as described in U.S. Pat. No. 6,321,914, for example with three stages, where the first stage, which is provided with first corrugated plate The second stage, which is positioned under the first stage, is provided with a second corrugated plate. Accordingly, from the first stage one stream of objects is formed as the objects slide from the first stage to the second stage, where four streams of objects are formed that leave the second stage and enter the third stage where finally six streams of objects are formed that leave the third stage and enter the in-feed end of the grading machine. In WO 03/043428 an in-feed distributing unit is presented having a partly movable (eccentric) movable base in-feeding unit. Additionally in U.S. Pat. No. 6,321,914 relates to grading unit having non-movable in-feed unit.

The problem with such feeding mechanism is how space demanding and slow it is and that the distribution and delivery of objects there from could be better.

### DESCRIPTION OF THE INVENTION

It is an object of the present invention to provide a feeding mechanism for objects such as capilion, herring and shrimps, that both requires less space than known mechanism and increases the distribution and correct the orientation of the objects before entering the in-feed part of grading machines.

According to the first aspect the present invention relates to an in-feed distributing unit for distributing an uneven stream of individual objects intended to be graded or handled in other way, wherein the distributing unit comprises.
a frame,
a first in-feeding unit,
a first conveyor arranged below said in-feeding unit having a first conveyor speed receiving objects from said first in-feed unit, and
alternatively a second conveyor arranged below said firs conveyor having a second conveyor speed receiving objects from said first conveyor,
grading unit arranged below said first or second conveyor for receiving and grading objects from said conveyors,
   wherein said first conveyor comprising a plurality of first set of divider plates and alternatively said second conveyor comprising a plurality of second set of divider plates, said plates arranged side by side and parallel to the conveying direction along the upper surface of said conveyor, thereby forming a plurality of conveying channels there in-between, and allowing delivery of said elongated objects onto said grading unit in a longitudinal direction.

In one preferred embodiment the in-feed distributing unit further comprises a plurality of additional dividing boards extended side-by-side substantially parallel to the conveying direction arranged in-between said grading means and said first or second conveyor adapted to ensure that the objects falling from said conveyor arrive at the grading unit parallel to it's conveying direction. Furthermore each respective dividing board is substantially parallel to the conveying direction. Additionally each respective board being triangular in shaped with two upwardly facing down-slanting sides. The dividing boards are step-wise shape in its longitudinal direction along the conveying direction. Said divider plates position is individually transversally adjustable.

The number of conveyors is at least two. The conveyor speed increase pr. conveyor in the conveying direction.

According to the second aspect the present invention relates to a method for distributing an uneven stream of individual elongated objects intended to be graded or handled in other way, said method comprising:
feeding the objects to be graded onto a first conveyor,
advancing said objects along a first and alternatively second conveyor having first and alternatively second conveying speed,
arranging plurality of dividing plates side by side and longitudinally along the upper surface of said conveyor, thereby forming a plurality of conveying channels there in-between,
delivering said objects from said conveyor onto a grader in a uniform longitudinal direction of conveyance.

The object may be marine species such as capilion and/or herring and/or shrimps.

### DETAILED DESCRIPTION

In the following the present invention and in particular preferred embodiments thereof are described in more details in connection with the accompanying drawings in which

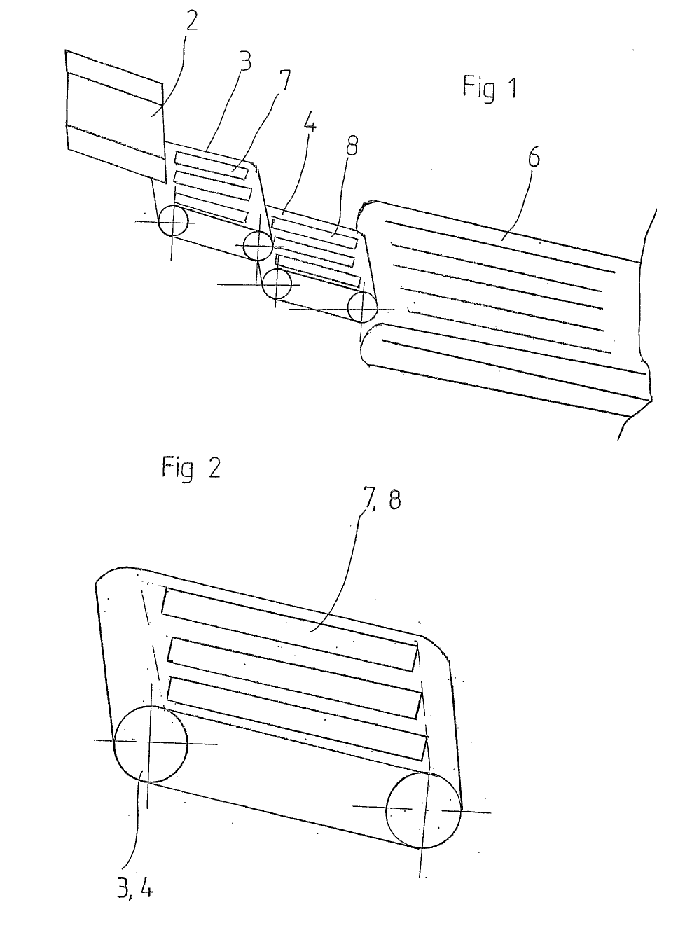

FIGS. 1 and 2 shows a side and top view of an in-feed distributing unit,

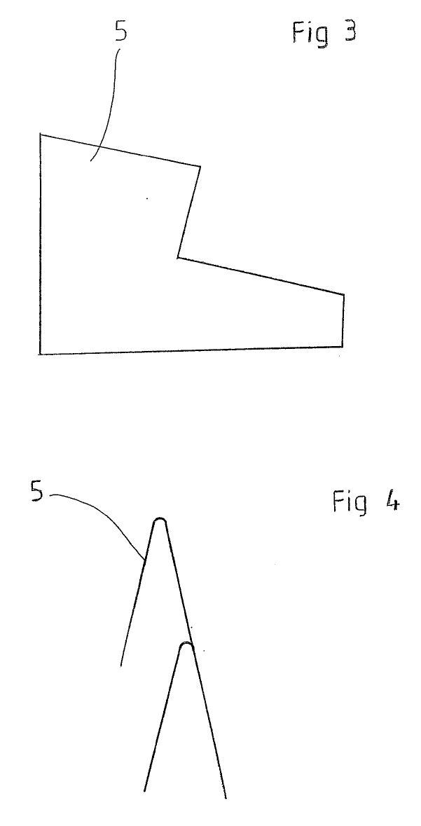

FIGS. 3 and 4 shows one embodiment of a dividing board adapted to ensure that the objects falling from a conveyor to a grading means lie parallel to the conveying direction,

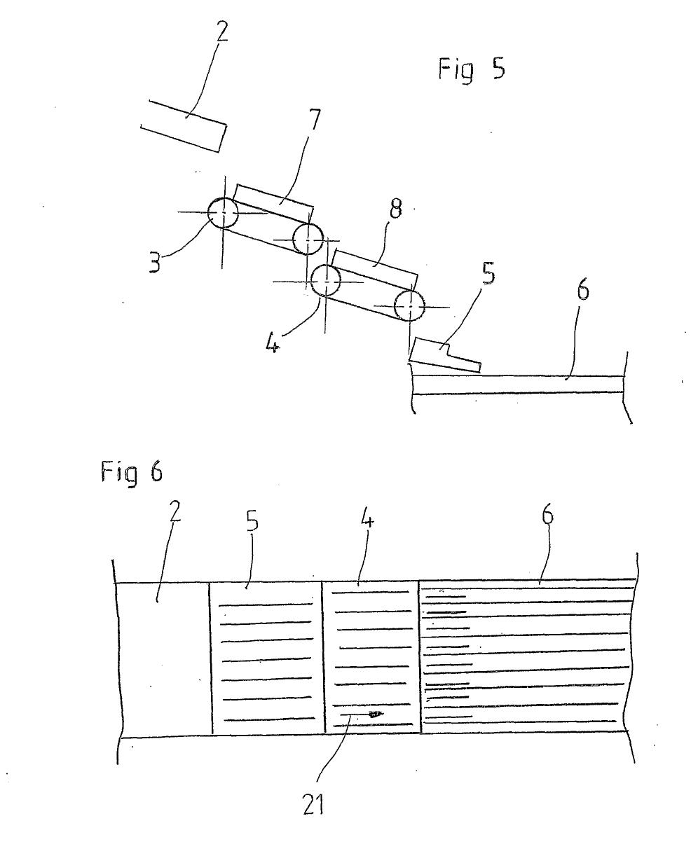

FIGS. 4 and 5 shows perspective view of the in-feed distributing unit,

FIGS. 1 and 2 shows a side and top view of the in-feed distributing unit, showing a first conveyor 3 running at a conveyor speed v1, and a second conveyor (4) running at a second conveyor speed v2, dividing boards (5), a grading unit (6). Each of the conveyor (3, 4) having a plurality of longitudinally arranged dividing plates (7, 8) forming plurality of channels there in-between.

When the objects, which may be capilion, herring or shrimps, enter the first conveyor they either directly enter the channels or are pulled therein by the conveyor. Due to the width of each channels, which is adjustable according to the objects (size) which is to be grades, the orientation of the object is rearranged to be longitudinal rather than transverse. The distance between the plates is thus adjusted to be small enough to allow longitudinal conveyance of the object, but not transverse, so that if the objects being fish its orientation is rearranged to become longitudinal.

FIG. 2 shows a top view of FIG. 1. At the in-feed device (2) the received object is relative localized while at the grading unit area (6) the objects have been distributed where they drop to the first conveyor (3), which is running at speed v1 which is preferably higher than the speed of the objects at the in-feed device (2). It follows that the objects are distributed additionally along the conveying direction indicated by the arrows in FIG. 2. In the embodiment shown in FIG. 1 and 2, there is second conveyor (4) running at speed v2, where v2 is larger than v1. Therefore, the objects are again distributed additionally in the conveying direction. The objects are here ready to be directed to the grading means, wherein the grading means may be similar as described in U.S. Pat. No. 6,065,607. A plurality of dividing boards (5) are arranged in between said grading means and the second conveyor (4) to further support that the orientation of the objects is parallel to the moving direction of the grading means as indicated by the arrows (21). The number of conveyors may easily be varied, i.e. from a single conveyor to a plurality of conveyors. This may depend on the products to be graded, the material of the conveyor belt, and the friction between the objects to be graded and the conveyor belt. What is essential here is that the distribution of the objects is sufficient so that the quality of the grading may be maximized.

FIGS. 3 and 4 show the side and a front view of one embodiment of the dividing boards. In this embodiment the dividing boards have stepwise construction. They may also be incline or have different shape (not shown). It is important that the construction of the dividing boards is such that when the object from the second conveyor fall onto the dividing boards the orientation of those objects, which is not parallel to the conveying direction, will be parallel to the conveying direction after falling onto the boards. The dividing boards are therefore adapted to correct the orientation of those objects which orientation is not suitable for the grading.

FIG. 5 shows a perspective view of FIG. 1 showing first in-feeding unit (2) delivering the objects to be graded onto the first conveyor (3). The conveyor running at a first conveyor speed (v1) having a plurality of dividing plates (7) forming plurality of conveying channels therein between. Elongated objects arriving at the conveyor are directed into the channels and their orientation adjuster so that when they are delivered from the conveyor either to the next conveyor (4) or the grading unit (6) they are lengthwise orientated in the conveyor direction.

FIG. 6 shows in further details on conveyor (3, 4) having a plurality of dividing plates (7, 8). As the objects enter the conveyor they fall or are pulled in between the dividing plates where their orientation rearranged to be longitudinal in the direction of conveyance in stead of transverse.

1. In-feed distributing unit for distributing an uneven stream of individual elongated objects prior to grading, comprising:
a frame,
a first in-feeding unit,
a first conveyor arranged below said in-feeding unit having a first conveyor speed receiving objects from said first in-feed unit, and
alternatively a second conveyor arranged below said first conveyor having a second conveyor speed receiving objects from said first conveyor,
grading unit arranged below said first or second conveyor for receiving and grading objects from said conveyors,
wherein said first conveyor comprises a plurality of first set of divider plates and alternatively said second conveyor comprising a second set of divider plates, said plates arranged side by side and parallel to the conveying direction along the upper surface of said conveyor, thereby forming a plurality of conveying channels there in-between, and allowing delivery of said elongated objects onto said grading unit in a longitudinal direction, a plurality of additional dividing boards extended side-by-side substantially parallel to the conveying direction arranged in-between said grading means and said first or second conveyor adapted to ensure that the objects falling from said conveyor arrive at the grading unit parallel to its conveying direction.

2. (canceled)

3. In-feed distributing unit according to claim 1, wherein each respective dividing board is substantially parallel to the conveying direction.

4. In-feed distributing unit according to claim 3, wherein each respective board being triangular in shaped with two upwardly facing down-slanting sides.

5. In-feed distributing unit according to claim 4, wherein said dividing boards are step-wise shape in its longitudinal direction along the conveying direction.

6. In-feed distributing unit according to claim 1, wherein the number of conveyors is at least two.

7. In-feed distributing unit according to claim 6, wherein the conveyor speed of successive conveyors increases in the conveying direction.

8. In-feed distributing unit according to claim 1, wherein said divider plates position is individually transversally adjustable.

9. A method for distributing an uneven stream of individual elongated objects intended to be graded or handled in another way, said method comprising:
feeding the objects to be graded onto a first conveyor,
advancing said objects along a first and alternatively a second conveyor having first and alternatively second conveying speeds,
arranging plurality of dividing plates side by side and longitudinally along the upper surface of said conveyor, thereby forming a plurality of conveying channels there in-between,
delivering said objects from said conveyor onto a grader in a uniform longitudinal direction of conveyance.

10. A method according to claim 8, wherein the number of conveyors is two or more.
